(19) United States
(12) Patent Application Publication
(10) Pub. No.: US 2008/0165125 A1
(43) Pub. Date: Jul. 10, 2008

(54) INPUT APPARATUS, INPUT METHOD AND CELLULAR TELEPHONE

(75) Inventor: Masafumi HOSONO, Kunitachi-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/756,497

(22) Filed: May 31, 2007

(30) Foreign Application Priority Data
Jan. 10, 2007 (JP) 2007-002659

(51) Int. Cl. G06F 3/033; G01P 1/02

(52) U.S. Cl. 345/157; 345/163; 455/550.1; 455/556.1; 73/493; 73/514.16

(57) ABSTRACT

Movement of a cellular telephone is detected by an acceleration sensor fixed on a housing (substrate), the cellular telephone and user's operations are detected by an acceleration sensor semifixed on the housing (substrate) via a flexible member, and the user's operations are detected on the basis of a difference between these detection results and a display process corresponding to the user's operations is executed.

### CROSS-REFERENCE TO RELATED APPLICATIONS

This application is based upon and claims the benefit of priority from prior Japanese Patent Application No. 2007-002659, filed Jan. 10, 2007, the entire contents of which are incorporated herein by reference.

### BACKGROUND OF THE INVENTION

1. Field of the Invention

The present invention relates to an input apparatus employed in, for example, cellular telephones, information communication devices, game machines and personal computers.

2. Description of the Related Art

An input apparatus employed for conventional cellular telephones, personal computers, etc. is operated in contact point mode, electrostatic capacity mode, magnet detection mode, etc.

In the contact point mode, a plurality of switches are dispersed as sensors and a mouse pointer, etc. are moved to a direction corresponding to a switch detecting user's operation. Since a plurality of switches are required in this mode, the device is large (cf., for example, JP-A No. 2005-166466 (KOKAI)).

In the electrostatic capacity mode, distribution of the electrostatic capacity of the sensor surface varied by finger touch is measured, user's intention is determined from the variation in the distribution, and the movement of a mouse pointer and operations of clicks are accepted. This mode has problems that operations cannot exactly be executed with a hand in a glove and the sense of operations can hardly be obtained, and that the material of a housing of built-in units is restricted since the electrostatic capacity is detected. In some apparatuses, electrodes are mounted on a substrate to solve these problems and the variation in the electrostatic capacity between the electrodes on the substrate and the electrodes of a device side is measured. However, since the electrodes need to be large to some extent, the device can hardly be downsized (cf., for example, JP-A No. 2006-059649 (KOKAI)).

In the magnet detection mode, a plurality of hole elements are dispersed as magnet sensors, user's intention is determined by detecting a magnet position moved by the user with the hole elements, and a mouse pointer is moved. In this mode, however, mounting positions of the magnet and the hole elements have low degree of freedom, and they cannot be mounted in the vicinity of devices such as speakers which generate magnetism (cf., for example, JP-A No. 2002-229731 (KOKAI)).

The conventional input apparatus has problems on operability and the dimensions of the mounting, and problem on restriction of the mounted units.

### BRIEF SUMMARY OF THE INVENTION

The present invention has been accomplished to solve the above-described problems. The object of the present invention is to provide an input apparatus, input method and cellular telephone which is superior in operability and which has small restriction in the dimensions of the mounting, and restriction of the mounted units.

To achieve this object, an aspect of the present invention is an input apparatus, comprising a first detector fixed on a substrate and configured to detect an acceleration, a second detector fixed on the substrate via a flexible member and configured to detect an acceleration, and a third detector configured to detect a user's request from a force applied to the second detector, in accordance with the acceleration detected by the first detector and the acceleration detected by the second detector.

According to the present invention, a first acceleration at a position fixed on the substrate is detected, a second acceleration at a second position fixed on the substrate via a flexible member is detected, and a force applied to the second position by the user is detected on the basis of the two accelerations.

Thus, the user can input the request by applying a force so as to deform the flexible member. The present invention can therefore provide the input apparatus which is excellent in operability and which has small restriction on the size on mounting and the mounted units.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a cellular telephone equipped with an input apparatus according to an embodiment of the present invention;

FIG. 2 is an illustration showing a configuration of an input device provided in an operating unit shown in FIG. 1;

FIG. 3 is an illustration showing a condition that the user applies pressure to the input device provided in an operating unit shown in FIG. 1;

FIG. 4 is an illustration showing a principle of an acceleration sensor shown in FIG. 2; and

FIG. 5 is an illustration showing a principle of an acceleration sensor shown in FIG. 2.

### DETAILED DESCRIPTION OF THE INVENTION

An embodiment of the present invention is described with reference to the accompanying drawings.

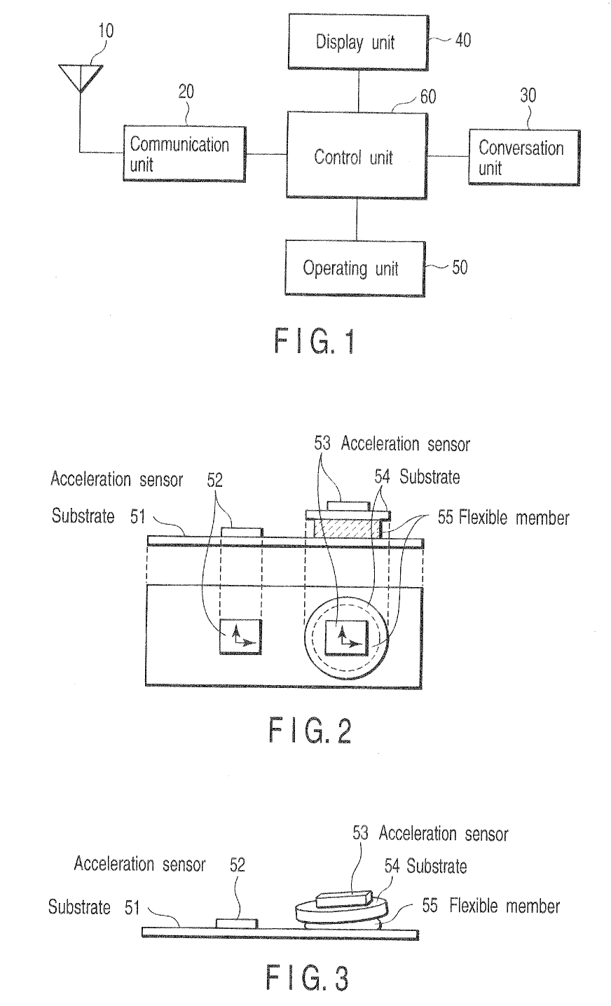

FIG. 1 shows a configuration of a cellular telephone equipped with an input apparatus according to an embodiment of the present invention. The cellular telephone comprises an antenna 10, a communication unit 20, a conversation unit 30, a display unit 40, an operating unit 50 and a control unit 60.

A radio signal sent from a base station (not shown) accommodated in a mobile communication network is received via the antenna 10. The received radio signal is subjected to frequency conversion, demodulation and decoding in the communication unit 20, and receive data are thereby obtained. The receive data are input to the conversation unit 30 via the control unit 60, and converted into an analog speech signal. The analog speech signal is output from a speaker (not shown) provided in the conversation unit 30, as conversation speech from a conversation partner.

In addition, the conversation unit 30 is equipped with a microphone (not shown) such that user's speech is converted into a send speech signal and then converted into speech data. The speech data are input to the communication unit 20 via the control unit 60. The communication unit 20 modulates a carrier with the speech data, frequency-converts a baseband signal thereby obtained into a radio frequency signal, which is sent to the base station via the antenna 10.

The display unit 40 is configured to display various kinds of visual information items such as pictures, characters, etc. under control of the control unit 60. The display unit 40 displays a mouse pointer, software keys such as icons, etc.

The operating unit 50 is configured to accept requests from the user. The operating unit 50 comprises an input device shown in FIG. 2, besides key input means comprising a plurality of keys.

The input device comprises a substrate 51, an acceleration sensor 52 provided directly on the substrate 51, an acceleration sensor 53, a substrate 54 on which the acceleration sensor 53 is placed, and a flexible member 55 to place the substrate 54 on the substrate 51. The flexible member 55 is formed of a flexible material (for example, resin) which can be deformed by force of a user's finger. When the user applies pressure (external pressure) to the acceleration sensor 53, the flexible member 55 is deformed as shown in, for example, FIG. 3, and the acceleration sensor 53 is thereby tilt. The user does not directly touch the acceleration sensor 53 though not shown in FIG. 2 or FIG. 3. The input apparatus comprises a resin-made key top so as to cover the acceleration sensor 53.

Each of the acceleration sensors 52 and 53 detects a biaxially generated acceleration.

The acceleration sensor may be, for example, a MEMS (Micro Electro Mechanical Systems) acceleration sensor, an electrodynamic acceleration sensor, a strain gauge acceleration sensor, a piezoelectric acceleration sensor, etc. and any sensor of them may be employed. An acceleration sensor conducting triaxial detection may also be employed.

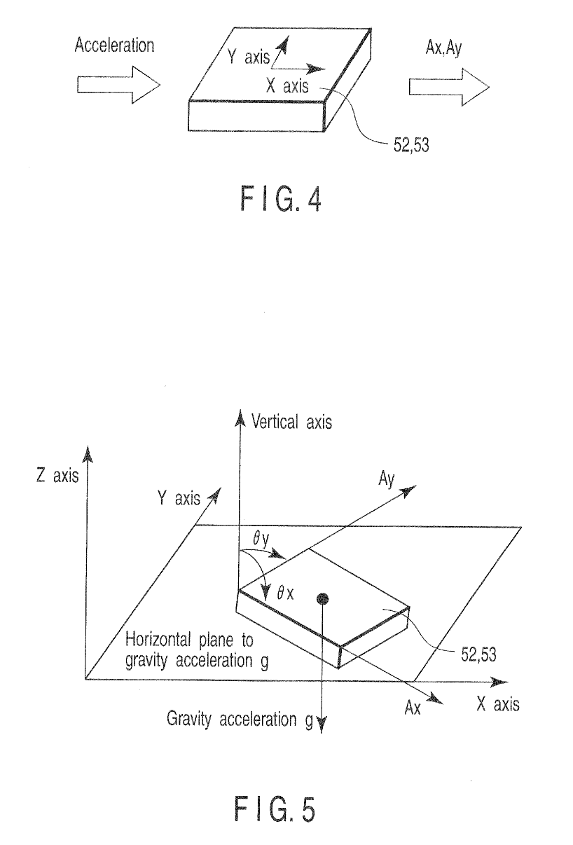

A sensor which detects a biaxially generated acceleration is described with reference to FIG. 4. Each of the acceleration sensors 52 and 53 outputs voltages Ax and Ay that correspond to magnitudes of X-axis component and Y-axis component of the acceleration applied thereto, respectively. In consideration of gravity acceleration g, the acceleration sensors 52 and 53 output voltages Ax=−A*g*cos θx, Ay=−A*g*cos θy, triaxialy, by receiving influence from the gravitational acceleration, as shown in FIG. 5. The x-y plane is horizontal to the direction of the gravity acceleration g.

The control unit 60 is configured to control all the units of the cellular telephone, and conducts control of original communication functions of the cellular telephone, display control of sending and receiving electronic mails, formation of electronic mails based on user's operations using the operating unit 50, information on the display unit 40, etc. As the display control, the control unit 60 controls the display information on the display unit 40, on the basis of the voltages Ax and Ay output from each of the acceleration sensors 52 and 53 of the operating unit 50.

More specifically, the control unit 60 obtains a difference between the voltage Ax output from the acceleration sensor 52 and Ax output from the acceleration sensor 53, and a difference between the voltage Ay output from the acceleration sensor 52 and the voltage Ay output from the acceleration sensor 53. Since the acceleration sensor 52 is fixed on the substrate which is moved synchronously with the entire body of the cellular telephone, the acceleration sensor 52 detects the entire body of the cellular telephone and the movement. On the other hand, since the acceleration sensor 53 is fixed on the substrate which is moved synchronously with the entire body of the cellular telephone, via the flexible member 55, the acceleration sensor 53 detects the entire body of the cellular telephone and the movement and, if the pressure is applied by the user, detects an acceleration generated by the pressure. For this reason, the difference between the voltages Ax and the difference between the voltages Ay as obtained by the control unit 60 represent the acceleration which is caused by the pressure applied by the user.

Then, the control unit 60 detects a direction of the pressure which is applied to the acceleration sensor 53 by the user, a variation (speed) per unit time of the pressure, a magnitude (strength) of the pressure, and an action (gesture, variation in direction), from the differences. The control unit 60 conducts display control of moving the mouse pointer displayed on the display unit 40 in the direction based on the detection result, and allows the displayed image to be scrolled. In addition, the control unit 60 controls the moving speed of the mouse pointer, the scroll speed and the scroll amount, in accordance with the detected speed and strength.

When the control unit 60 detects the pressure being applied in the direction of pushing down, the control unit 60 discriminates that a request for clicking an icon pointed on the display unit 40 by the mouse pointer and executes a process corresponding to the icon. Moreover, if the direction of the pressure reciprocates in a straight line or varies at a predetermined angle, when the control unit 60 detects that the user operation has been made to draw a predetermine orbit, the control unit 60 executes a preset process corresponding to those actions.

In the cellular telephone having the above constitution, the movement of the cellular telephone is detected by the acceleration sensor 52 fixed on the housing, the cellular telephone and the user's operation are detected by the acceleration sensor 53 semifixed on the housing via the flexible member 55, the user's operation is detected on the basis of the difference between these detection results and the display processing corresponding to the detected operation is executed.

Therefore, since the input apparatus has small restriction of mounting on the size and is not influenced by the magnetism, unlike the apparatus in the contact mode or the magnet detection mode, the degree of freedom of the mounting is high. Unlike the apparatus in the electrostatic capacity mode, the input apparatus has no problems of being hardly operable by a hand in a glove or having a poor sense of operation. In other words, the input apparatus is excellent in operability and has small restriction on the size of mounting and the mounted units.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, the control of the display information is described in the above embodiment. However, the other operations (outgoing operation and incoming call response operation, formation of electronic mails, etc.) of the cellular telephone can also be accepted from the user.

In addition, the input apparatus may comprise a sending unit of ultraviolet rays and Blue Tooth™ and conduct a remote operation of an external device by sending a radio signal to control the external device by user's operations via the operating unit 50.

Moreover, the input apparatus built in the cellular telephone is described. However, the input apparatus can be applied as a pointing device of a personal computer, a controller of a game machine, an operating device of an information communication device such as PDA (Personal Digital Assistance), and a remote controller of a video device such as a television set.

Otherwise, the present invention can be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An input apparatus, comprising:
a first detector fixed on a substrate and configured to detect an acceleration;
a second detector fixed on the substrate via a flexible member and configured to detect an acceleration; and
a third detector configured to detect a user's request from a force applied to the second detector, in accordance with the acceleration detected by the first detector and the acceleration detected by the second detector.

2. The apparatus according to claim 1, wherein the third detector detects a direction of an outer force applied to the second detector by the user as the user's request, in accordance with the acceleration detected by the first detector and the acceleration detected by the second detector.

3. The apparatus according to claim 1, wherein the third detector detects a magnitude of an outer force applied to the second detector by the user as the user's request, in accordance with the acceleration detected by the first detector and the acceleration detected by the second detector.

4. The apparatus according to claim 1, wherein the third detector detects a variation amount of an outer force applied to the second detector by the user as the user's request, in accordance with the acceleration detected by the first detector and the acceleration detected by the second detector.

5. The apparatus according to claim 1, further comprising:
a display unit configured to display visual information; and
a display controller configured to control the information displayed on the display unit, in accordance with the user's request detected by the third detector.

6. An input method, comprising:
a first detection of detecting an acceleration at a position fixed on a substrate;
a second detection of detecting an acceleration at a position fixed on the substrate via a flexible member; and
a third detection of detecting a user's request from a force applied to the fixed position of the second detection, in accordance with the acceleration detected in the first detection and the acceleration detected in the second detection.

7. The method according to claim 6, wherein a direction of an outer force applied to the second detection by the user as the user's request is detected in the third detection, in accordance with the acceleration detected by the first detection and the acceleration detected by the second detection.

8. The method according to claim 6, wherein a magnitude of an outer force applied to the second detection by the user as the user's request is detected in the third detection, in accordance with the acceleration detected by the first detection and the acceleration detected by the second detection.

9. The method according to claim 6, wherein a variation amount of an outer force applied to the second detection by the user as the user's request is detected in the third detection, in accordance with the acceleration detected by the first detection and the acceleration detected by the second detection.

10. The method according to claim 6, further comprising:
displaying visual information; and
controlling the information displayed on the display unit, in accordance with the user's request detected by the third detector.

11. A cellular telephone, comprising:
a first detector fixed on a substrate and configured to detect an acceleration;
a second detector fixed on the substrate via a flexible member and configured to detect an acceleration; and
a third detector configured to detect a user's request from a force applied to the second detector, in accordance with the acceleration detected by the first detector and the acceleration detected by the second detector.

12. The cellular telephone according to claim 11, wherein the third detector detects a direction of an outer force applied to the second detector by the user as the user's request, in accordance with the acceleration detected by the first detector and the acceleration detected by the second detector.

13. The cellular telephone according to claim 11, wherein the third detector detects a magnitude of an outer force applied to the second detector by the user as the user's request, in accordance with the acceleration detected by the first detector and the acceleration detected by the second detector.

14. The cellular telephone according to claim 11, wherein the third detector detects a variation amount of an outer force applied to the second detector by the user as the user's request, in accordance with the acceleration detected by the first detector and the acceleration detected by the second detector.

15. The cellular telephone according to claim 11, further comprising:
a display unit configured to display visual information; and
a display controller configured to control the information displayed on the display unit, in accordance with the user's request detected by the third detector.
